(19) United States
(12) Patent Application Publication
(10) Pub. No.: US 2023/0020720 A1
(43) Pub. Date: Jan. 19, 2023

(54) IMPROVED LEAD ACID BATTERY SEPARATORS AND BATTERIES CONTAINING THE SAME

(71) Applicant: Daramic, LLC, Charlotte, NC (US)

(72) Inventors: J. Kevin Whear, Utica, KY (US); Eric H. Miller, Philpot, KY (US)

(21) Appl. No.: 17/783,512

(22) PCT Filed: Dec. 7, 2020
(86) PCT No.: PCT/US2020/063552

§ 371 Date: Jun. 8, 2022

Related U.S. Application Data
(60) Provisional application No. 62/945,514, filed on Dec. 9, 2019.

(51) Int. Cl. H01M 50/454; H01M 10/12; H01M 50/417; H01M 50/434; H01M 50/446; H01M 50/489

(52) U.S. Cl. CPC H01M 50/454; H01M 10/121; H01M 10/123; H01M 50/417; H01M 50/434; H01M 50/446; H01M 50/489; H01M 2220/20

(57) ABSTRACT

Disclosed in at least one embodiment herein is a battery separator comprising a substrate that may be polymeric and porous. The substrate may have ribs, protrusions, or ribs and protrusions on one or both faces or surfaces thereof. On at least one surface or face of the substrate, a material layer may be formed. The material layer may contain a material with an oil absorption value equal to or greater than 15 g oil/100 g of material. The battery separator disclosed herein is useful in a lead acid battery, particularly in a flooded lead acid battery or a valve-regulated lead acid (VRLA) battery. The battery separator described herein has many benefits including helping mitigate or prevent issues such as acid stratification and others that may deteriorate battery performance or battery life.

### FIELD

The present disclosure relates to novel or improved separators for a variety of lead acid batteries and/or systems. In addition, exemplary embodiments disclosed herein are directed to novel or improved battery separators, battery cells incorporating the same, batteries incorporating the same, systems incorporating the same, and/or methods of manufacturing and/or of using the same, and/or the like, and/or combinations thereof.

### BACKGROUND

The lead acid battery is a highly economical solution to energy storage and has been the preferred energy source of starting vehicles for approximately 100 years. During most of these 100 years, the primary role of the lead acid battery has been to simply start the engine a few times a day and then provide power for emergency lighting when and if the vehicle became disabled because of an engine malfunction. To start a vehicle, the lead acid battery typically discharges less than 5% of its full capacity and soon recharges to 100% charge by the operational engine. Thus, the traditional lead acid battery used in automotive applications has typically operated at 100% charge.

In order to improve fuel economy and reduce tailpipe emissions, manufacturers have designed vehicles, generally called Idle Stop-Start (“ISS”) vehicles, such that their engines turn off more frequently. ISS vehicle engines turn off when the vehicle has stopped, and automatically restart when it is time for the vehicle to be mobile again. Typically, the engine restarts upon the release of the brake pedal. In addition to restarting the engine, ISS vehicle batteries are required to provide energy for vehicle accessories when the engine is off. Such exemplary accessories may be the HVAC system, heated seats, radios, lights, and the like. When these vehicles operate in stop-and-go traffic, such as that in a city setting or other congested areas, the lead acid battery typically operates in a partial state of charge (“PSoC”) and may never (or rarely) experience a fully charged condition. A PSoC exists when a battery operates at a charge of less than 100%, and typically continues in this manner through multiple discharge and charge cycles without reaching a 100% charge. This operation in a PSoC has highlighted all manner of weaknesses in the current state of the art in lead acid battery technology. Thus, there currently remain unmet needs in lead acid battery technology.

Referring to FIG. 1, a typical lead acid battery 50 has a positive terminal 51 and a negative terminal 53. The terminals 51, 53 are typically disposed on the top or side of the battery 50. Within the battery, an electrode/separator array 50a encompasses alternating positive electrodes 52 and negative electrodes 54, and a porous or microporous separator 100 disposed and interleaved between each positive electrode 52 and negative electrode 54. The positive terminal 51 is in electrical communication with the positive electrodes 52. Likewise, the negative terminal 53 is in electrical communication with the negative electrodes 54. The separators 100 are shown with leaf or cut-piece separators 100, however they may alternatively be formed as positive envelopes (i.e., enveloping the positive electrodes), negative envelopes (i.e., enveloping the negative electrodes), hybrid envelopes, pockets, sleeves, wraps, and/or the like, and/or a combination thereof. Typically, the separator may comprise a microporous silica filled polyethylene (PE) membrane separator having backweb 102 or 202 or a backweb (102 or 202) and ribs or protrusions 104. 102n or 202n denotes a negative face or surface of the backweb and 102p or 202p denotes a positive face or surface of the backweb.

Typical positive electrodes 52 have a current carrying grid, made predominately of lead dioxide (PbO₂), and typically doped with a positive active material (“PAM”). Typical negative electrodes 54 have a current carrying grid, made predominately of lead (Pb), and typically doped with a negative active material (“NAM”). Both of the PAM and NAM contribute to increasing the functionality of the electrodes. The positive and negative grids may encompass alloys having at least one of antimony (Sb), calcium (Ca), tin (Sn), selenium (Se), and/or the like, or a combination thereof.

An aqueous electrolyte 56 solution substantially submerges the electrodes 52, 54 and separators 100. In lead acid batteries, the electrolyte 56 solution acts as both an electrolyte and as a reactant, and is typically a solution of water and sulfuric acid (H₂SO₄). The electrolyte solution typically has an optimal specific gravity of approximately 1.280 (1280 Kg/m³), with a range of approximately 1.215 (1215 Kg/m³) to approximately 1.300 (1300 Kg/m³).

The purpose of the separator is to physically separate and insulate the electrodes from electrical conduction with one another, which would short the battery, yet maintain ionic conduction between the electrodes via the electrolyte, which is required for the electrochemical reaction of the battery. Therefore, the separator must be electrically non-conductive (other than, for example, a carbon coating on one side) to electrically separate the electrodes, yet porous enough to allow ionic conduction (such as via the electrolyte that fills the pores). If the separator is too porous or has pores that are too large, then dendrites are likely to form large enough to bridge the gap between the electrodes and short the battery. Extremely large pores may also allow direct physical contact between the electrodes. Because the electrolyte also acts as a reactant, the separator must also allow enough acid to contact and interact with the electrodes.

The reaction at the lead dioxide (PbO₂) positive (+) electrode (the “positive half-reaction”) supplies electrons and is left positive. This positive half-reaction during discharge at the lead dioxide (PbO₂) positive (+) electrode produces lead sulfate (PbSO₄) and water (H₂O), shown below in Eq. 1:

PbO₂+SO₄⁻²+4H⁺+2e⁻↔PbSO₄+2H₂O (Eq. 1)

where:
PbO₂ is the solid lead dioxide positive (+) electrode;
SO₄⁻² is aqueous;
4H⁺ is aqueous;
2e⁻ is in the solid lead dioxide (PbO₂) positive (+) electrode;
PbSO₄ is a solid precipitate within the aqueous electrolyte; and
H₂O is a liquid in the aqueous electrolyte.

The positive half-reaction is reversible upon charging the battery.

The negative half-reaction at the lead (Pb) negative (−) electrode (the “negative half-reaction”) supplies positive ions and is left negative. The negative half-reaction during discharge produces lead sulfate (PbSO₄) and negative ions (el, shown below in Eq. 2:

Pb+SO₄⁻²↔PbSO₄+2e⁻ (Eq. 2)

where:
Pb is the solid lead negative (−) electrode;
SO₄⁻² is aqueous;
PbSO₄ is a solid precipitate within the aqueous electrolyte; and
2e⁻ is in the lead (Pb) negative (−) electrode;

The negative half-reaction is reversible upon charging the battery.

Together, these half-reactions give way to the overall chemical reaction of the lead acid battery, shown below in Eq. 3:

Pb+PbO₂+2H₂SO₄↔2PbSO₄+2H₂O (Eq. 3)

where:
Pb is the solid negative (−) electrode;
PbO₂ is the solid positive (+) electrode;
H₂SO₄ is a liquid within the aqueous electrolyte;
PbSO₄ is a solid precipitate within the aqueous electrolyte; and
H₂O is a liquid within the aqueous electrolyte.

The overall chemical reaction is reversible upon charging the battery. For each of the above reactions, discharge occurs moving from left to right, and charging occurs moving right to left. During discharging cycles, both the positive (+) and negative (−) electrodes convert at least partially into lead sulfate (PbSO₄) and the electrolyte loses much of its sulfuric acid (H₂SO₄) and becomes mostly water. As shown in FIG. 2A, a predominately-discharged battery cell has two electrodes 52, 54 of lead sulfate and dilute sulfuric acid, with a separator 100 disposed between the electrodes 52, 54. As shown in FIG. 2B, a battery cell with 100% charge has an electrode of lead dioxide 52, an electrode of lead 54, a sulfuric acid electrolyte, with a separator 100 disposed between the electrodes 52, 54.

A particular weakness of typical lead acid batteries operating in a PSoC is the production of lead sulfate (PbSO₄) during discharging cycles. As shown in the equations above (see, Eq. 1, Eq. 2, and Eq. 3), both electrodes consume the sulfuric acid from the electrolyte, leaving the electrolyte with a lower specific gravity. Simultaneously, the electrodes at least partially convert to lead sulfate. The lead sulfate is more voluminous than lead, which leads to the active material (e.g., NAM and PAM) swelling. If this active material is not restrained, it will shed with time and shorten the life of the battery. When the active material is restrained, it maintains contact with the current carrying grid and easily converts from lead sulfate to lead. Generally, the active material is essentially unsupported in a typical flooded battery. In valve regulated lead acid (“VRLA”) batteries, the absorptive glass mat (“AGM”) separator provides more support in that it is in full contact with the active material. Though it provides support, the AGM separator is infinitely compressible and does not fully resist the swelling of the active material during discharge. Though the AGM separator may prevent shedding, the active material may lose electrical connection to the current collector and remain in the sulfated state.

Another particular weakness of typical lead acid batteries operating in a PSoC is that the electrolyte becomes stratified. During charging cycles, the electrodes convert from the sulfated state while producing sulfuric acid (H₂SO₄). The acid produced is at a higher concentration than that of the rest of the electrolyte, which is diluted sulfuric acid. In addition, sulfuric acid is more dense than water. Therefore, the bulk of the produced acid will sink to the bottom of the cell/battery and ultimately stratify with a higher concentration of acid at the bottom of the electrolyte. Acid stratification shortens life of the battery, deteriorates battery electrical performance, and can cause battery management systems to yield false signals that the battery is charged.

Yet another particular weakness of typical lead acid batteries operating in a PSoC relates to the fact that the battery is typically located in the vehicle's engine bay. For a variety of reasons, vehicle manufacturers are continuously optimizing the use of the volume within a vehicle. As such, the engine bay has become smaller and more and more crowded resulting in reduced airflow through the engine bay. With reduced airflow and operation in hot climates, a typical lead acid battery may see temperatures in excess of 80° C. the positive electrode may produce oxidizing species at the surface that can degrade typical polyethylene separators. Furthermore, elevated temperatures only accelerate by orders of magnitudes the oxidizing reactions that further hasten the degradation of polyethylene separators.

There remains a need to, at least partially, address the above problems or issues relating to weaknesses known to typical lead acid batteries operating in a PSoC. The present application and inventors provide, as described herein, a novel battery separator that will preferably provide adequate support against active material swelling, reduce, mitigate, or eliminate acid stratification, and be highly oxidative resistant. The same novel separator will preferably maintain current benefits of existing separators, such as polyethylene separators, that include low ionic resistance, good puncture resistance, envelopability, and remain highly cost effective. As of this application filing, the inventors know of no battery separator that is capable of providing all these characteristics in the fashion or embodiments described herein. Accordingly, the present invention preferably aims to meet at least these and other heretofore-largely unmet needs.

### SUMMARY

For at least certain applications or batteries, the details of one or more exemplary embodiments, aspects, or objects of the present invention at least provide for battery separators having a variable overall thickness, such as an overall thickness that varies as a function of pressure applied to the separator. Other features, objects, and advantages of the present invention provide for reduced battery failure, improved battery cycle life, and/or improved performance. More particularly, there remains a need to provide a separator capable of adapting to varying electrode spacing, during at least one of the battery's production and/or in use after its manufacture.

The details of one or more exemplary embodiments, aspects, or objects are in the detailed description and claims set forth hereinafter. Other features, objects, and advantages will be apparent from the detailed description and claims set forth hereinafter. In accordance with one or more select embodiments, aspects, or objects, the present disclosure or invention at least addresses the problems, issues, or needs enumerated herein, and in some cases provides a solution that surprisingly and unexpectedly exceeds needs and expectations.

In accordance with at least certain exemplary embodiments, objects, or aspects, the present disclosure or invention may provide novel or improved separators, cells, batteries, systems, methods of manufacture, use, and/or applications of such novel or improved separators, cells, batteries, and/or systems that overcome at least the aforementioned problems. For example, at least certain exemplary embodiments, objects, or aspects provide batteries with separators that are adaptable to electrodes with varied spacing therebetween, and by providing batteries with separators having variable thicknesses.

In accordance with at least selected exemplary embodiments, aspects, or objects, the present disclosure or invention provides a separator whose components and physical attributes and features synergistically combine to address, in surprising and unexpected ways, previously unmet needs in the lead acid battery industry with an improved battery separator. In certain preferred exemplary embodiments, the present disclosure or invention provides a battery using a separator as described herein to address, in surprising and unexpected ways, previously unmet needs in the lead acid battery industry with an improved lead acid battery separator. In certain preferred exemplary embodiments, the present disclosure or invention provides a system using a battery as described herein to address, in surprising and unexpected ways, previously unmet needs in the lead acid battery industry with an improved system utilizing an inventive lead acid battery that utilizes an inventive separator as described herein.

In accordance with at least certain embodiments, the present disclosure or invention relates to novel or improved separators, cells, batteries, systems, and/or methods of manufacture and/or use and/or applications of such novel separators, cells, batteries, and/or systems. In accordance with at least certain embodiments, the present disclosure or invention is directed to novel or improved battery separators for: lead acid batteries; flooded lead acid batteries; enhanced flooded lead acid batteries (“EFBs”); flat-plate batteries; tubular batteries; deep-cycle batteries; batteries operating in a partial state of charge (“PSoC”); valve regulated lead acid (“VRLA”) batteries; gel batteries; absorptive glass mat (“AGM”) batteries; inverter batteries; stationary batteries; batteries used while in motion; energy storage for electricity generation, such as by steam turbine generators, such as by coal and/or gas fired power plants, and/or nuclear power plants; energy storage for electricity generation by solar power, wind power, hydro-electric power, or other alternate and/or renewable energy sources; general energy storage batteries; uninterruptible power source (“UPS”) batteries; batteries with high cold-cranking ampere (“CCA”) requirements; vehicle batteries, such as starting-lighting-ignition (“SLI”) vehicle batteries, idling-start-stop (“ISS”) vehicle batteries, marine batteries, automobile batteries, truck batteries, motorcycle batteries, all-terrain vehicle batteries, forklift batteries, golf cart (also referred to as golf cars) batteries, hybrid-electric vehicle (“HEV”) batteries, electric vehicle batteries, light electric vehicle batteries, neighborhood electric vehicle (“NEV”) batteries, e-rickshaw batteries, e-trike batteries, e-bike batteries, electric scooter batteries; and/or the like; and/or combinations thereof. In accordance with select embodiments, the present disclosure or invention relates to battery separators for use in systems or vehicles incorporating the above-mentioned batteries. In accordance with at least certain aspects, the present disclosure or invention relates to improved methods of making and/or using such improved separators, cells, batteries, systems, and/or the like.

In one aspect, a battery separator is described that comprises, consists of, or consists essentially of the following: (1) a polymeric substrate; and (2) a material layer provided on at least one surface of the polymeric substrate. In some preferred embodiments, the material layer may be provided on two or two or more surfaces of the polymeric substrate.

Regarding the polymeric substrate, in preferred embodiments, the polymeric substrate is a flexible polymeric substrate. In some embodiments, the oil content of the polymeric substrate is from 1 to 20%, from 1 to 10%, or from 1 to 5%. The polymeric substrate may be a nonwoven or a woven polymeric substrate. The polymeric substrate may be a sheet or an envelope.

In some preferred embodiments, the polymeric substrate is a polymeric porous membrane having a positive face and a negative face, where each of the positive face and the negative face optionally have ribs, protrusions, or both ribs and protrusions. The porous polymeric membrane may have pores with an average pore size is less than about 1 micron. The polymeric porous membrane may be perforated, microporous, nanoporous, macroporous, or mesoporous. The polymeric porous membrane may comprise a polyolefin, including at least one of polyethylene, polypropylene, and blends or copolymers thereof. The polymeric porous membrane may also further comprise a filler in addition to the polyolefin.

In embodiments where ribs are present, the ribs may be at least one selected from continuous ribs, discontinuous ribs, longitudinally extending ribs, latitudinally extending ribs, diagonally extending ribs, integral ribs, non-integral ribs, and mini ribs. In some embodiments where ribs are present on a face of the porous membrane, ribs, protrusions, or both ribs and protrusions may not be present on one or more outer edges of the membrane. In such embodiments, if ribs or protrusions are present on one or more outer edges of the membrane, then they will be mini ribs or mini protrusions. Mini ribs or protrusions may have a height of, at most, 100 microns to 250 microns from a face of the polymeric porous membrane.

The thickness of the polymeric substrate may range from 50 to 500 microns. In embodiments where ribs, protrusions, or both ribs and protrusions are formed on a face of the substrate, the thickness of the backweb (not including the rib height) is 50 to 500 microns. In some embodiments, the combined thickness of the polymeric substrate and the material layer may be from 125 microns to 4 mm.

Regarding the material layer, the material layer may be provided on the positive face, on the negative face, or on both the positive and the negative face of the polymeric porous membrane described above. The material layer may be provided on a side or face having ribs, protrusions, or both ribs and protrusions, or the material layer may be provided on a side or face that does not have ribs, does not have protrusions, or does not have ribs or protrusions. In embodiments where the material layer is provided on a side or face that does have ribs, protrusions, or both ribs and protrusions, the material layer may be provided at least between any two ribs, any two protrusions, or between a rib and a protrusions. However, in embodiments where mini ribs or mini protrusions are present on an outer edge of the membrane, it is preferred that the material layer is not provided between these mini ribs, between these mini protrusions, or between a mini rib and a mini protrusion.

In embodiments where the material layer is provided between two ribs, between two protrusions, or between a rib and a protrusion, the material layer may partially fill, completely fill, or overfill the area between two ribs, between two protrusions, or between a rib and a protrusion.

In some preferred embodiments, the material layer comprises, consists of, or consists essentially of a material that has an oil absorption greater than 15 g of oil/100 g. The oil absorption of the material may also be greater than 25 g of oil/100 g of the material, from 25 g of oil/100 g of the material to 100 g of oil/100 g of the material, from 25 g of oil/100 g of the material to 200 g of oil/100 g, of from 25 g of oil/100 g of the material to 300 g of oil/100 g of the material.

The material may be at least one selected from the group consisting of silica, precipitated silica, fumed silica, a talc, diatomaceous earth, a polysulfone, a polyester, PVC, and combinations thereof. In some embodiments, the material may be an organic or inorganic particulate that is at least one of hydrophilic, acid loving, and acid stable. In some embodiments, the material may comprise particles with different average sizes.

In some embodiments, the material layer may comprise, consist of, or consist essentially of the material as described above and a binder. The binder may be present in an amount less than 50%, and in some embodiments may be present in an amount between 1-20%. The binder may be one that is soluble, partially soluble, or insoluble in a battery acid such as H2SO4.

In some embodiments, the material layer may further comprise, consist of, or consist essentially of at least one additional material. The additional material does not necessarily have to have the oil absorption characteristics of the material, but it can. The additional material, in some preferred embodiments, is at least one selected from the group consisting of carbon, a water-loss-reducing agent, a fatty alcohol, a surfactant, a wetting agent, a zinc salt, any other battery performance-enhancing additive, and combinations thereof.

In some embodiments, the material or the material layer may have a bulk density in the range of 0.1 to 3.5 g/cm³.

In some embodiments, an additional layer is provided on the material layer. The additional layer may comprise, consist of, or consist essentially of at least one selected from the group consisting of carbon, a water-loss-reducing agent, a fatty alcohol, a surfactant, a wetting agent, a zinc salt, a metal sulfate, any other battery performance-enhancing additive, and combinations thereof. The additional layer may also comprise, consist of, or consist essentially of a binder or other additive, or combinations thereof.

In another aspect, a lead acid battery, which may include a flooded lead acid battery or a valve-regulated lead acid battery, is described herein. In some embodiments, the lead acid battery may comprise the following: (1) a negative plate; (2) a positive plate; (3) an acid-containing electrolyte; and (4) a battery separator as described herein that is placed between at least one negative and at least one positive plate. The lead acid battery may be a cylindrical-cell-type or a prismatic-cell-type.

The material layer of the battery separator may be formed between the polymeric substrate and the positive plate, between the polymeric substrate and the negative plate, or between the polymeric substrate and both the positive and the negative plate.

In some embodiments, an additional layer may be formed between the polymeric substrate and the negative and/or positive plates. The additional layer may comprise, consist of, or consists essentially of at least one of carbon, a water-loss-reducing agent, a fatty alcohol, a surfactant, a wetting agent, a zinc salt, a metal sulfate, any other battery-performance-enhancing additive, and combinations thereof.

The lead acid battery described hereinabove or the battery separator contained therein may exhibit or does at least one, at least two, at least three, or all of the following properties: (1) immobilizes at least a portion of the acid-containing electrolyte; (2) is not infinitely compressible; (3) improves oxidation resistance allowing for thinner and more porous base or substrate material; or (4) restrains active material in at least one of the positive or negative plates (NAM or PAM).

In another aspect, a Valve-Regulated Lead Acid (VRLA) battery is described herein. The improvement of the VRLA described herein is the replacement of at least one absorptive glass mat (AGM) with a battery separator as described herein. The VRLA battery may be a cylindrical-cell-type or a prismatic-cell-type.

The material layer of the battery separator may be formed between the polymeric substrate and a positive plate of the VRLA battery, between the polymeric substrate and a negative plate of the VRLA, or between the polymeric substrate and both a positive and a negative plate of the VRLA battery.

In some embodiments, an additional layer may be formed between the polymeric substrate and the negative and/or positive plates. The additional layer may comprise, consist of, or consists essentially of at least one of carbon, a water-loss-reducing agent, a fatty alcohol, a surfactant, a wetting agent, a zinc salt, any other battery-performance-enhancing additive, and combinations thereof.

The VRLA battery or the separator therein may exhibit, one, two, or all of the following properties: (1) immobilizes at least a portion of the acid-containing electrolyte; (2) is not infinitely compressible; and (3) restrains active material in at least one of the positive or negative plates (NAM or PAM).

### BRIEF DESCRIPTION OF THE FIGURES

FIG. 1 is a schematic cutaway side-view of a typical lead acid battery having a plurality of alternating positive (+) electrodes and negative (−) electrodes, and separators interleaved therebetween.

FIG. 2A is a schematic of a typical lead acid battery cell in a substantially discharged state. FIG. 2B is a schematic of a lead acid battery cell in a substantially charged state.

FIG. 3A is a plan-view depiction of a typical separator having a first surface or face with a plurality of ribs longitudinally disposed thereon, extending therefrom, and being substantially parallel to the machine direction. FIG. 3B shows a plan-view depiction of the separator shown in FIG. 3A having a second surface or face, opposite to the first surface or face, with a plurality of optional negative cross-ribs 106 laterally disposed thereon, extending therefrom, and being substantially parallel to the cross-machine direction.

FIG. 4A is an end-view representation of a typical separator having major ribs and a flat backweb. FIG. 4B is an end-view representation of a typical separator having major ribs and negative cross-ribs 106 on an opposite surface.

FIG. 5A is an end-view illustration of a typical electrode/separator assembly in a fully charged state. FIG. 5B is an end-view illustration of a typical electrode/separator assembly in a fully discharged state. FIG. 5C is a section-view detail along line A-A of FIG. 5A.

FIG. 6A is an end-view schematic of an exemplary embodiment of the present invention having positive ribs. FIG. 6B is an end-view schematic of an exemplary embodiment of the present invention having a flat porous membrane without ribs. FIG. 6C is an end-view drawing of an electrode/separator assembly with the separator of FIG. 6A in either a charged or a discharged state. The material layer is designated 210 in these Figures.

FIG. 7A is a section-view along line B-B of FIG. 6C. FIG. 7B is a side view detail similar to that of FIG. 7B, with an exemplary inventive separator with negative cross-ribs.

FIG. 8A is a plan-view of an exemplary embodiment with flat backweb separator without ribs, protrusions, or ribs and protrusions. If ribs or protrusions are present in the side regions, they are mini ribs or protrusions. FIGS. 8B and 8C are end views of exemplary embodiments as envelope separators. Back web is 202 and side regions without ribs or protrusions are 212. 200 denotes the separator. 214 denotes a sealed area of the formed envelopes shown in 8B and 8C.

FIG. 9 is an end-view schematic of an exemplary embodiment of the present invention having positive ribs.

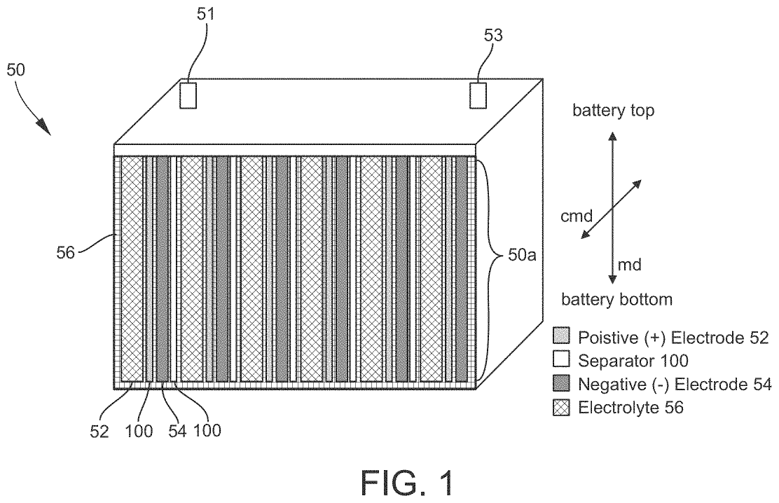

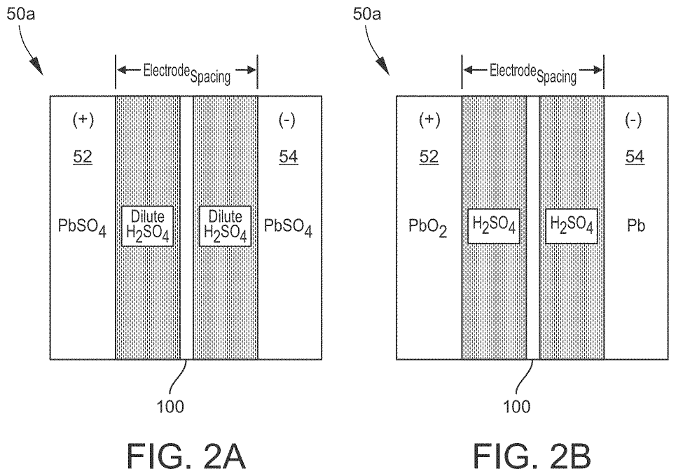

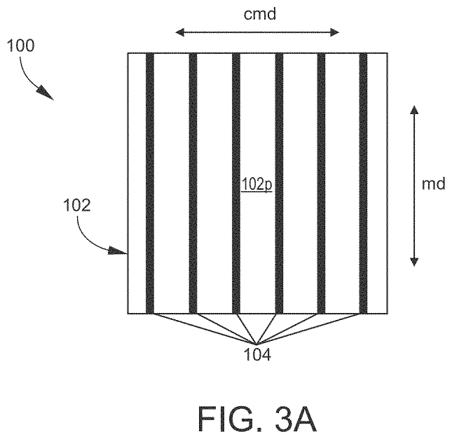

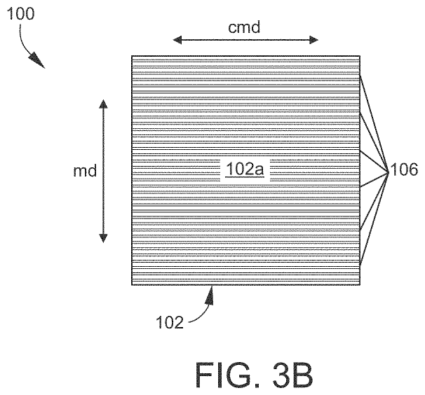

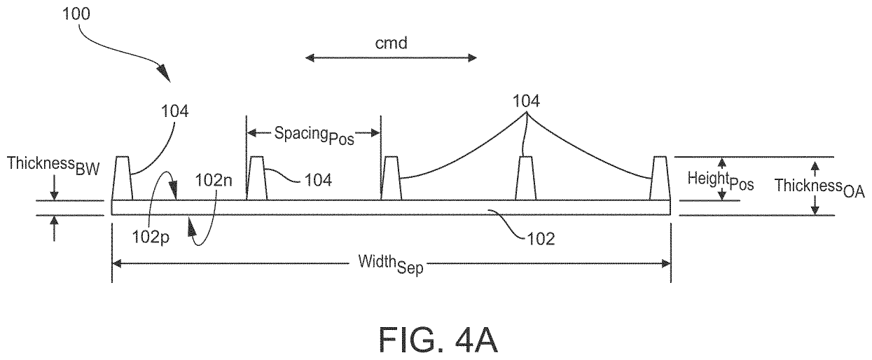

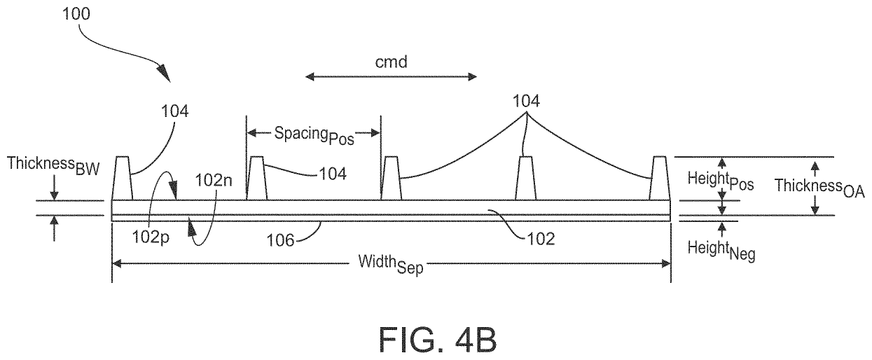

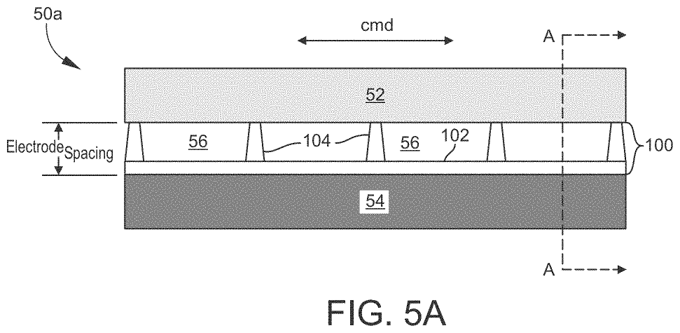

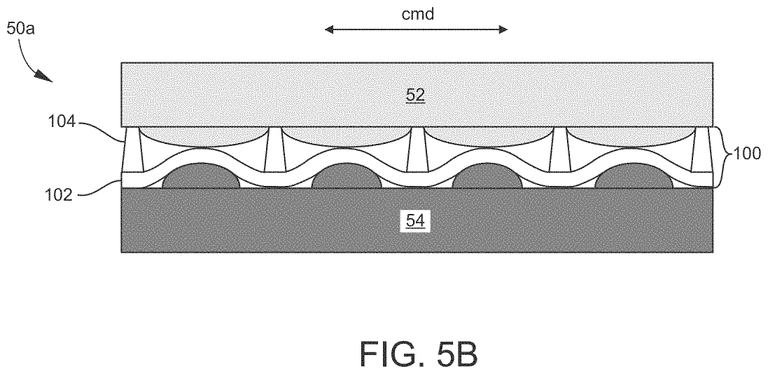

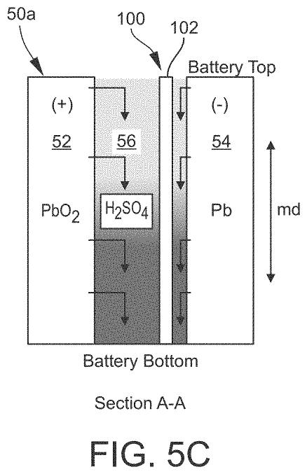

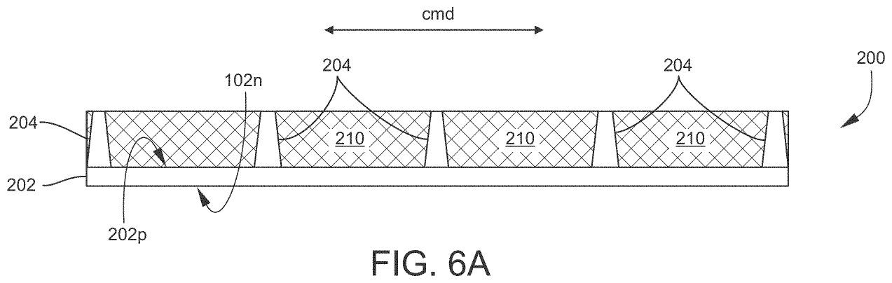

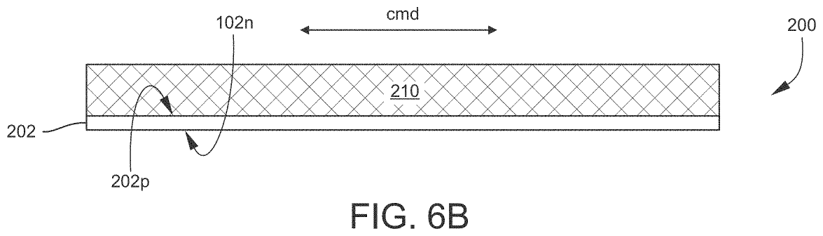

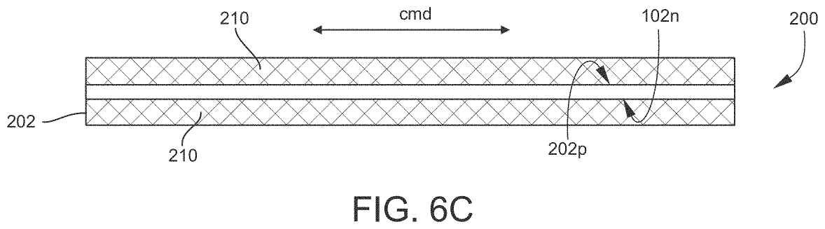

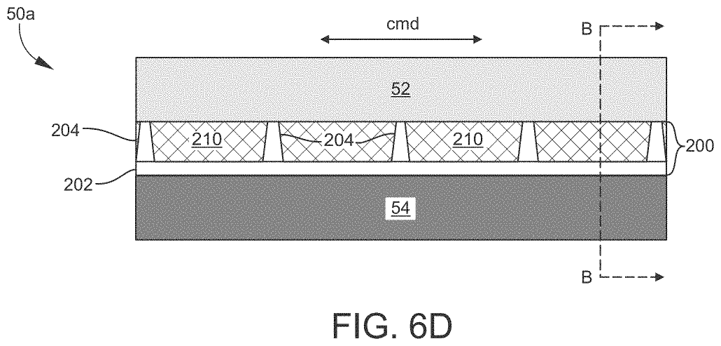

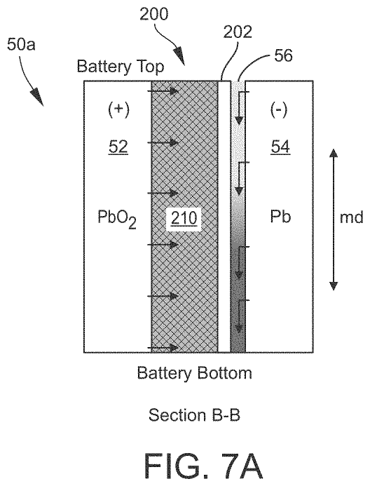

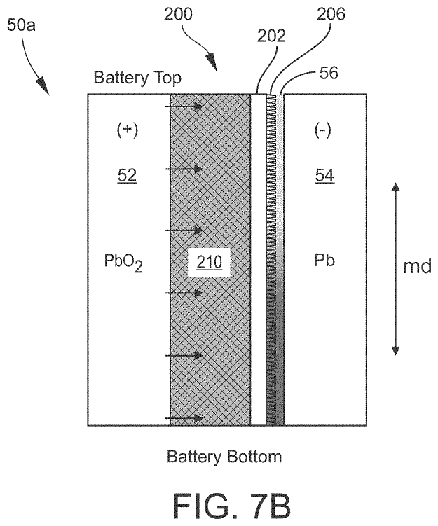

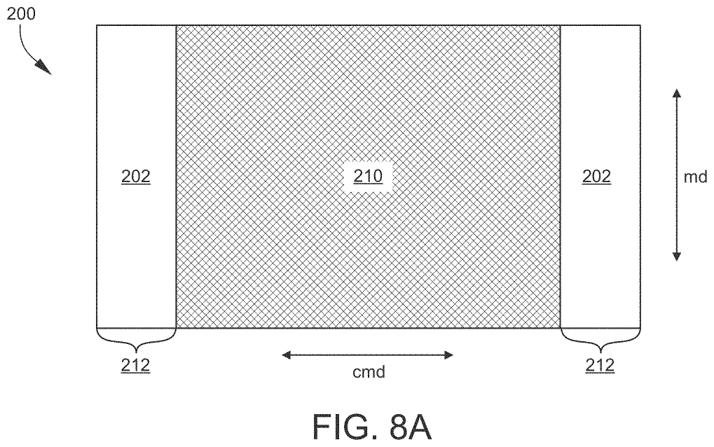

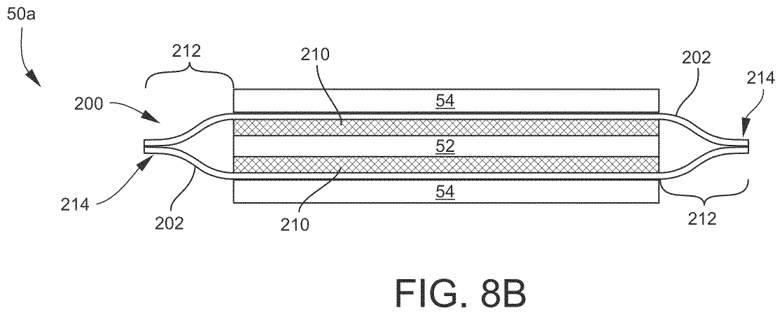

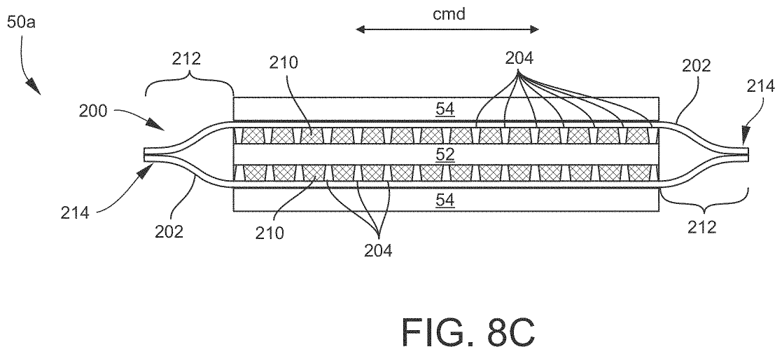

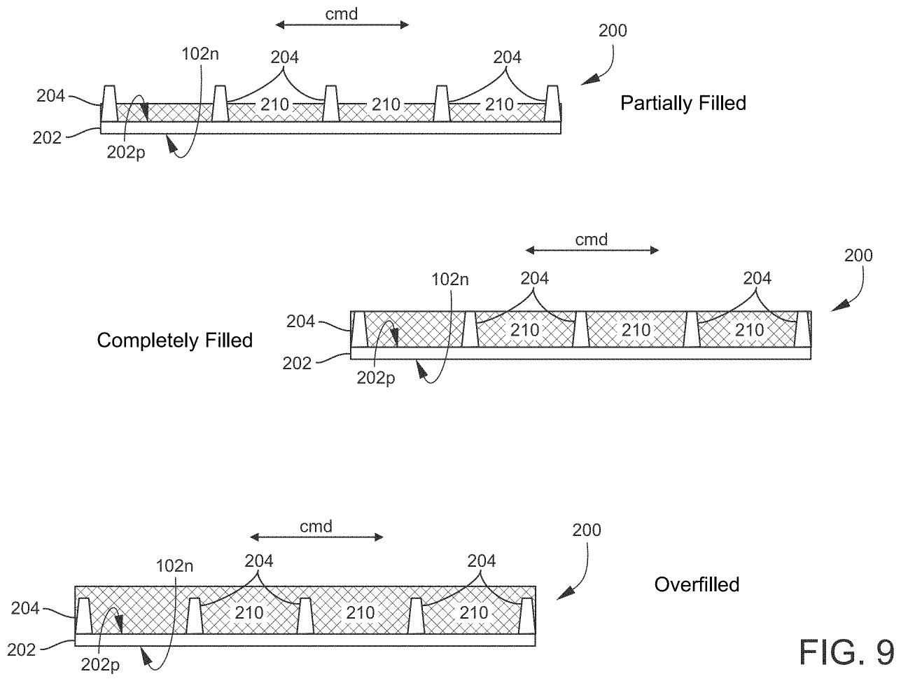

### DETAILED DESCRIPTION

Described herein is an improved battery separator for a lead acid battery, including a flooded lead acid battery or valve regulated lead acid (VRLA) battery. The battery separator described herein may also replace one or more absorptive glass mats (AGMs) in a VRLA battery. There are many benefits of using the improved battery separator described herein. One benefit is that the battery separator described herein is not infinitely compressible like a typical AGM. Another benefit of the battery separator described herein is its ability to restrain liquid electrolyte, which may help in preventing acid stratification, which as explained hereinabove negatively effects battery life and performance. Another benefit that the battery separator described herein may exhibit is an ability to restrain negative active material (NAM), positive active material (PAM) or both NAM and PAM, which may swell, grow, and/or expand during battery operation. These benefits, in addition to others, are realized by the improved battery separator disclosed herein.

Battery Separator

The structure of the battery separator described herein is not so limited, but in preferred embodiments, the battery separator may have the following structure: (1) a substrate and (2) a material layer formed on at least one surface or face of the substrate. In other embodiments, another layer (3) may be formed as part of the structure. The particulars of the substrate, the material layer, and the optional other layer are described above and in more detail below.

(1) Substrate

The substrate of the battery separator is not so limited and may be polymeric or non-polymeric. It may be porous or non-porous. However, in preferred embodiments, the substrate is flexible, polymeric, and porous or perforated. For example, many commercially available battery separators sold by DARAMIC® may be used as the polymeric substrate of the battery separator described herein. For example, Daramie HiCharge™, Daramic® HP™, DuraLife®, Daramic® HD™, or Daramic® HD Plus™, Darak®, XCHarge™, HiCharge™, Daramic® EFS™, or Daramic® IND CL™ may be used. The substrate may be formed by a variety of processes including, but not limited to an extrusion process, a casting process, a process typical for forming a nonwoven including a spun bond process, or a process typical for forming a woven.

The composition of the polymeric substrate is not so limited. The polymeric substrate may have a composition that includes at least one of the polymers, thermoplastic polymers, polyvinyl chlorides (“PVCs”), phenolic resins, natural or synthetic rubbers, synthetic wood pulp, lignins, glass fibers, synthetic fibers, cellulosic fibers, and/or combinations thereof. The natural or synthetic rubbers may include one or more of rubber, latex, natural rubber, synthetic rubber, cross-linked or uncross-linked natural or synthetic rubbers, cured or uncured rubbers, crumb or ground rubber, polyisoprenes, methyl rubber, polybutadiene, chloroprene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers, and/or combinations thereof.

In some aspects of the present invention, the polymeric substrate's composition may further possess a filler. In some embodiments, that filler is at least one of silica, dry finely divided silica, precipitated silica, amorphous silica, highly friable silica, alumina, talc, fish meal, fish bone meal, barium sulfate (BaSO₄), carbon, conductive carbon, graphite, artificial graphite, activated carbon, carbon paper, acetylene black, carbon black, high surface area carbon black, graphene, high surface area graphene, ketjen black, carbon fibers, carbon filaments, carbon nanotubes, open-cell carbon foam, a carbon mat, carbon felt, carbon Buckminsterfullerene (“Bucky Balls”), an aqueous carbon suspension, flake graphite, oxidized carbon, and/or combinations thereof.

In some embodiments, the composition of the polymeric substrate may further comprise a processing oil left over from manufacture of the substrate. One benefit of the battery separator described herein is the ability to reduce processing oil content in the substrate below 20%, below 15%, below 10%, or below 5%. For example, the processing oil content may be reduced as low as 1% or less, 2% or less, 3% or less, 4% or less, 5% or less, 6% or less, 7% or less, 8% or less, 9% or less, 10% or less, 11% or less, 12% or less, 13% or less, 14% or less, 15% or less, 16% or less, 17% or less, 18% or less, 19% or less, or 20% or less. Conventionally, significant amounts of processing oil was left behind was to, among other things, improve oxidation resistance. However, with the addition of the material layer on at least one surface of the polymeric substrate in the battery separator described herein, the concern of oxidation resistance of the substrate is lower and amounts of remaining processing oil in the substrate can be reduced. Reducing the amount of processing oil can have the positive effect of increasing ionic conductivity of the substrate and/or lowering the electrical resistance across the substrate. Thus, the ability to have lower amounts of remaining processing oil in the substrate is significant and may lead to improved separator performance. Although the ability to lower processing oil content of the substrate is a benefit made possible by the structure of the improved battery separator described herein, embodiments of the battery separator where the substrate has a processing oil content above 20% are also workable and have other benefits.

In some embodiments, one or more surface or face of the substrate may have ribs, protrusions, or both ribs and protrusions. In embodiments where ribs are present, the ribs do not have any particular structure but the may be at least one of the following: continuous ribs, discontinuous ribs, longitudinally extending ribs, latitudinally extending ribs, diagonally extending ribs, integral ribs, non-integral ribs, mini ribs, and combinations thereof. For example, the ribs could be discontinuous and diagonally extending ribs. Protrusions are not ribs. One example of a protrusions may include, but is not limited to, dimples. When ribs, protrusions, or ribs and protrusions are formed on both faces of the substrate, the types of ribs, protrusions, or ribs and protrusions formed on each face or surface may be the same or different. For example, latitudinally extending ribs may be formed on one face or surface of the substrate and longitudinally extending ribs may be formed on the other face or surface.

In some embodiments when ribs, protrusions, or ribs and protrusions are formed on a surface of the substrate, one or more edge regions of the substrate may not include ribs, protrusions, or ribs and protrusions or the one or more edge regions may only include mini ribs, mini protrusions, or mini ribs and protrusions. A mini rib or mini protrusion may have a maximum height from the face of the substrate to the highest point of the rib or protrusion that is at most 100 to at most 250 microns from the face of the substrate. In some embodiments, the maximum height may be at most 75 microns, at most 50 microns, at most 25 microns, at most 125 microns, at most 150 microns, at most 175 microns, at most 200 microns, or at most 225 microns. This type of structure may be useful if the final structure of the battery separator is a pouch or sleeve that involves welding of the edges of the substrate material to form. In such embodiments where regions with no ribs or protrusions (or only mini ribs or protrusions) are formed, it is preferred that no material layer be formed in these regions either.

In some embodiments, the thickness of the substrate may be in the range of 50 to 500 microns, 75 to 500 microns, 100 to 500 microns, 125 to 500 microns, 150 to 500 microns, 175 to 500 microns, 200 to 500 microns, 225 to 500 microns, 250 to 500 microns, 300 to 500 microns, 325 to 500 microns, 350 to 500 microns, 375 to 500 microns, 400 to 500 microns, 425 to 500 microns, 450 to 500 microns, or 475 to 500 microns. In embodiments, where ribs are formed on one or more surfaces of the substrate, the thickness of the substrate is the thickness of what is often referred to the backweb, which is the substrate not considering the height of the ribs formed thereon.

(2) Material Layer

The material layer is formed on one or more partial or entire surfaces of the substrate described herein above.

The composition of the material layer is not so limited. In some embodiments, the layer may comprise, consist of, or consist essentially of a material having an oil absorption value greater than 15 g of oil/100 g of the material, greater than 25 g of oil/100 g of the material, greater than 50 g of oil/100 g of the material, greater than 75 g of oil/100 g of the material, greater than 100 g of oil/100 g of the material, greater than 125 g of oil/100 g of the material, greater than 150 g of oil/100 g of the material, greater than 175 g of oil/100 g of the material, greater than 200 g of oil/100 g of the material, greater than 225 g of oil/100 g of the material, greater than 250 g of oil/100 g of the material, greater than 275 g of oil/100 g of the material. The oil absorption value may be 20, 30, 40, 50, 60, 70, 80, 90, 100, 110, 120, 130, 140, 150, 160, 170, 180, 190, 200, 210, 220, 230, 240, 250, 260, 270, 280, 290, or 300 g of oil/100 g of the material. In some embodiments, the oil absorption value of the material is from 25 g of oil/100 g of material to 300 g of oil/100 g of the material. Oil absorption is used as the measure here as a proxy for the amount of battery acid that might be absorbed into the material. Oil absorption may be measured by the appropriate ASTM test method for a particular material or any other suitable method for measuring oil absorption. Porosity, overall surface areas, and other features of a material are properties that may affect the oil absorption value of a given material.

In some embodiments, the material may have a bulk density in the range from 0.1 to 3.5 g/cm³, in the range from 0.2 to 3.5 g/cm³, in the range from 0.3 to 3.5 g/cm³, in the range from 0.4 to 3.5 g/cm³ in the range from 0.5 to 3.5 g/cm³ in the range from 0.6 to 3.5 g/cm³, in the range from 0.7 to 3.5 g/cm³, in the range from 0.8 to 3.5 g/cm³, in the range from 0.9 to 3.5 g/cm³ in the range from 1.0 to 3.5 g/cm³ in the range from 1.1 to 3.5 g/cm³, in the range from 1.2 to 3.5 g/cm³, in the range from 1.3 to 3.5 g/cm³, in the range from 1.4 to 3.5 g/cm³ in the range from 1.5 to 3.5 g/cm³ in the range from 1.6 to 3.5 g/cm³, in the range from 1.7 to 3.5 g/cm³, in the range from 1.8 to 3.5 g/cm³, in the range from 1.9 to 3.5 g/cm³ in the range from 2.0 to 3.5 g/cm³ in the range from 2.1 to 3.5 g/cm³, in the range from 2.2 to 3.5 g/cm³, in the range from 2.3 to 3.5 g/cm³, in the range from 2.4 to 3.5 g/cm³ in the range from 2.5 to 3.5 g/cm³ in the range from 2.6 to 3.5 g/cm³, in the range from 2.7 to 3.5 g/cm³, in the range from 2.8 to 3.5 g/cm³, in the range from 2.9 to 3.5 g/cm³ in the range from 3.0 to 3.5 g/cm³ in the range from 3.1 to 3.5 g/cm³, in the range from 3.2 to 3.5 g/cm³, in the range from 3.3 to 3.5 g/cm³, or in the range from 3.4 to 3.5 g/cm³. In some embodiments, the bulk density may be less than 0.1 g/cm³ or greater than 3.5 g/cm³.

In some embodiments, the material of the material layer may comprise, consist of, or consist essentially of at least one selected from silica, precipitated silica, fumed silica, a talc, diatomaceous earth, a polysulfone, a polyester, PVC, and combinations thereof.

In some embodiments, the material may comprise, consist of, or consist essentially of one or more organic or inorganic particulates having at least one of the following properties: being hydrophilic, being acid loving, and being acid stable.

In some embodiments, the material may further comprise, consist of, or consist essentially of a battery-performance-enhancing additive. The additive is not so limited, but may be, for example, at least one selected from a wetting agent, a surfactant, a water-loss-reducing agent, an agent for increasing charge acceptance, a fatty alcohol, a zinc salt, carbon, and combinations thereof.

In some embodiments, the material has a single average particle size with a wide or narrow particle size distribution. In some embodiments, the material includes a first portion with a first average particle size and particle size distribution and a second portion with a second distinct (smaller or larger) average particle size and a particle size distribution that is overlapping or non-overlapping with the particle distribution of the first portion. Without wishing to be bound by any particular theory, it is believed that having at least two portions with different particle sizes and/or different particle size distributions may help increase the packing density of the material.

In some embodiments, the material layer may further comprise, consist of, or consist essentially of a binder. For example, in some embodiments the material layer may comprise, consist of, or consist essentially of the material as described above and a binder or the material, a binder, and an additive such as a battery-performance-enhancing additive. In some embodiments, the amount of binder in the material layer may be 50% or less, 45% or less, 40% or less, 35% or less, 30% or less, 25% or less, 20% or less, 15% or less, 10% or less, 5% or less, 4% or less, 3% or less, 2% or less, or 1% or less.

The type of binder used is not so limited. In some preferred embodiments, the binder may be a polymeric binder. In some embodiments, the binder may be insoluble, partially soluble, or soluble in battery acid such as H₂SO₄. In some embodiments, it may be preferred for the binder to be soluble or partially soluble in battery acid such that when the battery separator described herein is placed in a lead acid battery, part of the binder will dissolve possibly leaving the material layer more porous than it was before the battery separator was placed into the battery.

In some embodiments, the material layer itself may have a bulk density in the range from 0.1 to 3.5 g/cm³, in the range from 0.2 to 3.5 g/cm³, in the range from 0.3 to 3.5 g/cm³, in the range from 0.4 to 3.5 g/cm³, in the range from 0.5 to 3.5 g/cm³, in the range from 0.6 to 3.5 g/cm³, in the range from 0.7 to 3.5 g/cm³, in the range from 0.8 to 3.5 g/cm³, in the range from 0.9 to 3.5 g/cm³, in the range from 1.0 to 3.5 g/cm³, in the range from 1.1 to 3.5 g/cm³, in the range from 1.2 to 3.5 g/cm³, in the range from 1.3 to 3.5 g/cm³, in the range from 1.4 to 3.5 g/cm³, in the range from 1.5 to 3.5 g/cm³, in the range from 1.6 to 3.5 g/cm³, in the range from 1.7 to 3.5 g/cm³, in the range from 1.8 to 3.5 g/cm³, in the range from 1.9 to 3.5 g/cm³, in the range from 2.0 to 3.5 g/cm³, in the range from 2.1 to 3.5 g/cm³, in the range from 2.2 to 3.5 g/cm³, in the range from 2.3 to 3.5 g/cm³, in the range from 2.4 to 3.5 g/cm³, in the range from 2.5 to 3.5 g/cm³, in the range from 2.6 to 3.5 g/cm³, in the range from 2.7 to 3.5 g/cm³, in the range from 2.8 to 3.5 g/cm³, in the range from 2.9 to 3.5 g/cm³, in the range from 3.0 to 3.5 g/cm³, in the range from 3.1 to 3.5 g/cm³, in the range from 3.2 to 3.5 g/cm³, in the range from 3.3 to 3.5 g/cm³, or in the range from 3.4 to 3.5 g/cm³. In some embodiments, the bulk density may be less than 0.1 g/cm³ or greater than 3.5 g/cm³. The bulk density may be measured before or after the material layer (as part of the battery separator) has been used in a lead acid battery as described herein.

In some embodiments, the material layer may be applied to a surface of the substrate described herein that has ribs, protrusions, or ribs and protrusions. In some embodiments, the material layer is applied to a surface or face of the substrate that does not have any ribs or any protrusions. In some embodiments, the material layer is provided on a surface that has ribs or protrusions and on a surface or face that does not have any ribs or protrusions.

When the material layers is provided on a face or surface with ribs, protrusions, or both ribs and protrusions, the material layers is provided in an area between at least two ribs, at least two protrusions, or a rib and a protrusion. In some embodiments, there may be a material layer present in the area between all the ribs, all the protrusions, or all the ribs and protrusions. In some embodiments, there may be a material layer present only in the area between some ribs, some protrusions, or some ribs and protrusions. The material layer may partially fill, completely fill, or over fill the area between two ribs, two protrusions, or a rib and a protrusion. Partially filled may mean that between 1 and 99% of the area is filled. In some preferred embodiments, it may mean that 50% or more, 60% or more, 70% or more, 80% or more, 90% or more, or 95% or more of the area is filled.

(3) Another Optional Layer

In some embodiments, an optional layer may be provided in contact with the material layer. The composition of the optional layer is not so limited. In some embodiments, the layer may comprise, consist of, or consist essentially of one or more battery-performance-enhancing additive as described herein. In some embodiments, the layer may comprise, consist of, or consist essentially of one or more battery-performance-enhancing additive as described herein and one or more binders as described herein. In some embodiments, the layer may comprise, consist of, or consist essentially of one or more battery-performance-enhancing additive as described herein, one or more binders as described herein, and another additive.

The optional layer may have a thickness from 1 to 300 microns, 1 to 250 microns, 1 to 200 microns, 1 to 150 microns, 1 to 100 microns, or 1-50 microns.

In some embodiments, one or more battery-performance-enhancing additives may be present in the material layer and in the another optional layer.

Battery

Any battery separator described herein may be used in a lead acid battery, particularly a flooded-type lead acid batter or valve regulated lead acid (VRLA) battery. In a valve-regulated lead acid battery, the battery separator described herein may replace at least one absorptive glass mat (AGM), some of the AGMs, or all of the AGMs. The battery separator described herein offers several benefits compared to an AGM battery separator. As one example, the battery separator is not infinitely compressible like an AGM, which offers advantages in at least a cylindrical-type battery cell. Being infinitely compressible is also an undesirable from a standpoint of withstanding pressure due to positive active material (PAM) and negative active material (NAM) swelling during battery operation.

The structure of the lead acid battery is not so limited, but in preferred embodiments, the lead acid battery may comprise at least the following: (1) a positive electrode or plate, (2) a negative electrode or plate, (3) a battery separator as described herein between the positive and negative plate, and (4) an electrolyte. The active layer of the battery separator described herein may be on a side closest to the positive plate, on a side closest to the negative plate, or on a side closest to the negative plate and a side closest to the positive plate.

In accordance with at least certain aspects, objects or embodiments, the present application or invention may address or at least partially address, some of the above mentioned problems or issues relating to known to typical lead acid batteries operating in a PSoC. In accordance with at least certain aspects, objects or embodiments, the present application or invention provides, as described herein, a novel battery separator that will preferably provide adequate support against active material swelling, reduce, mitigate, or eliminate acid stratification, and be highly oxidative resistant. The same novel separator will preferably maintain current benefits of existing separators, such as polyethylene separators, that include low ionic resistance, good puncture resistance, envelopability, and remain highly cost effective. In accordance with at least certain aspects, objects or embodiments, the present invention preferably aims to meet at least these and other heretofore-largely unmet needs.

Disclosed in at least one embodiment herein is a battery separator comprising a substrate that may be polymeric and porous. The substrate may have ribs, protrusions, or ribs and protrusions on one or both faces or surfaces thereof. On at least one surface or face of the substrate, a material layer may be formed. The material layer may contain a material with an oil absorption value equal to or greater than 15 g oil/100 g of material. The battery separator disclosed herein is useful in a lead acid battery, particularly in a flooded lead acid battery or a valve-regulated lead acid (VRLA) battery. The battery separator described herein has many benefits including helping mitigate or prevent issues such as acid stratification and others that may deteriorate battery performance or battery life.

In some embodiments, the lead acid battery may be a cylindrical-cell-type or a prismatic-cell type lead acid battery, an accumulator, a storage battery, or the like.

The separator may be calendered to for example, set the final height or thickness, to compact the coating or material, and/or the like.

In the batteries described herein, the battery separator performs one, two, three, or all four of the following: immobilizes at least a portion of the acid-containing electrolyte helping with acid stratification; is not infinitely compressible, which helps with cell manufacture; and restrains active material in at least one of the positive or negative plates (NAM or PAM) because unrestrained NAM or PAM may shed; improves oxidation resistance allowing for the use of thinner and more porous base material in the separator as described in the Examples below.

When used herein, solubility in acid may be determined in some instances by looking at a material's (e.g., a binder's) oxidation resistance in that acid. Low oxidation resistance may indicate a soluble binder and high oxidation resistance may indicate an insoluble binder. A partially soluble binder would have a mid-range (between high and low) oxidation resistance.

When used herein, hydrophilicity of a material may be determined in some instances by looking at the wet out time of the separator having a material layer comprising, consisting of, or consisting essentially of that material. For example, a wet out time less than 10 minutes, less than 9 minutes, less than 8 minutes, less than 7 minutes, less than 6 minutes, less than 5 minutes, less than 4 minutes, less than 3 minutes, less than 2 minutes, less than 1 minute, or less than 30 seconds. Less than 3 minutes is preferable in some instances.

When used herein, the acid loving nature of a material may be determined in some instances by looking at the wet out time of the separator having a material layer comprising, consisting of, or consisting essentially of that material. For example, a wet out time less than 10 minutes, less than 9 minutes, less than 8 minutes, less than 7 minutes, less than 6 minutes, less than 5 minutes, less than 4 minutes, less than 3 minutes, less than 2 minutes, less than 1 minute, or less than 30 seconds. Less than 3 minutes is preferable in some instances.

When used herein, the term acid stable may be determined in some instances by looking at a material's oxidation resistance in acid. A material with low oxidation resistance is considered less stable in acid than a material with high oxidation resistance. A weight loss test may be performed to measure oxidation resistance.

### EXAMPLES

### Example 1—PE Ribbed Substrate+Silica Material Layer on Ribbed Side Used in Flooded Lead Acid Battery

As a starting point, the novel invention will be first explained in turns of the separator used in an Enhanced Flooded Battery (EFB). The EFB has a typical electrode spacing of approximately 0.8 mm. In this space, a PE separator (substrate) is placed. The backweb of the separator is typically 0.20 mm and the ribs that protrude from this surface are another 0.60 mm, thus the total thickness of the separator is 0.80 mm. A typical automotive separator may have 11 to 30 ribs across the surface of the separator. The present invention, in some embodiments takes the typical PE separator and applies highly porous silica particles having an oil absorption greater than 15 g of oil/100 g of silica in the space between the ribs. To function in highly automated equipment the silica will have to be attached to the separator substrate and to adjacent silica particles. The action of binding or adhering the silica can be done by appropriate selection of chemicals currently available. For example a binder as described herein is used.

To start, the silica agglomerate is approximately 85% porous in and of itself. Then, as the particles are randomly arranged in the space between the ribs, they will create a semi-rigid porous structure to serve a multitude of purposes. First, the semi-rigid porous structure will uniformly support the active material that swells during discharge. In this way the active material will not be unsupported and allowed to swell and form large crystals of stable lead sulfate and effectively non-porous and prevent the acid from reacting with the active material. These large areas are predominately consist of lead sulfate, which effectively an insulator and a highly effective barrier for the acid to have intimate contact with the active lead particles. Left in this state long enough, the large areas of lead sulfate will ultimately lose contact and from the other active material and shed off the electrode surface area. The benefit of the invention is the silica-coated separator will uniformly support the active material, prevent regions of swelling and create optimum utilization of active material and extend life when it is due to active material shedding. In applications where laminates such as glass mats or pasting papers are used to minimize active material shedding, they can be suppressed and the present invention can be employed.

After shedding, the layer of highly porous silica with high surface area will be useful to immobilize the acid preventing stratification. Upon charging, pure sulfuric acid is generated at the electrode surface. This acid has density higher than the bulk acid and will tend to stratify. With a layer of silica pressed up against the positive electrode, the acid will be held in place by the interstitial porous structure of the silica. The primary manner to overcome acid stratification is to overcharge the battery and produce oxygen and hydrogen with the electrolysis of water. These gases will rise in the acid and evacuate through the vent ports. As they rise, the gases will carrying the heavy liquids upward and mix the acid. However, in a partial state of charge operation, the battery may not necessarily see an overcharge condition and therefore the primary means of acid mixing is gone. In addition, if we can prevent acid stratification, then we no longer need an overcharge condition. Minimizing the number of overcharge conditions will lower water loss and slow down the rate of grid corrosion.

Another benefit of the current invention can be seen in regard to the oxidation attack. As electrodes are made thinner, the associated separator spacing is also made thinner. Therefore, the opportunity for oxidative attack on the separator increases. With regard to this attack, it is critical the back web thickness or the continuous substrate of the separator is not compromised. If it is compromised with a hole, crack or split, this is a place for electronic conductance to occur from opposing electrodes, which would result in a short. As the oxidizing attack is initiated at the positive electrode, the silica-coated surface will provide an extra layer of oxidation protection. With this layer of silica on the substrate, one could even think of making the substrate thinner (<150 microns) or greater porosity (>62%) or the combination of both. Separator with thinner backweb and higher porosity will result in lower separator ionic or electrical resistance thus providing greater power for the battery during a high discharge.

All the benefits described can also be applied lead acid batteries used in other applications such as golf cart, renewable energy, back-up power and a means of energy for electric fork trucks. In these applications, the electrode spacing is typically thicker and thus the overall thickness of the separator is also greater than those found in an automotive battery. Yet the benefits application of this new separator can also be applied in a similar manner.

### Example 2—PE Ribbed Substrate+Silica Material Layer on Ribbed Side Used in a Valve-Regulated Lead Acid (VRLA) Battery

Example 1 is describing the flooded lead acid batteries. However, one could imagine that the aforementioned silica coated separator (PE ribbed substrate+silica material layer on the ribbed side) could also work in non-flooded applications also called starve electrolyte of valve regulated lead acid (VRLA) batteries. These come in few configurations. First, configuration is what is commonly called a gel or Dry-fit battery. In this application, a polyethylene or cross-linked separator, the acid electrolyte is mixed with fumed silica to create a thixotropic condition and then added to the battery. In this condition, the electrolyte is immobilized, which prevents stratification. With this particular invention, no thixotropic condition is needed; the acid can be added to the battery and silica coated separator will serve to immobilize the electrolyte.

Another type of VRLA battery is often referred to as an AGM battery. Here, the separator is comprised of absorptive micro fiber glass mat also known as an AGM separator. These separators sufficiently immobilize the acid; however, they have some deficiencies. In general, the pores of the AGM separator range from five to 25 microns and thus they do not sufficiently provide protection against shorting. Thus, when AGM batteries are used in deep cycling application, they are likely to fail due to shorts. Therefore, the idea is to use a sub-micron substrate, such as the PE separator, and coat it with highly porous silica. The PE separator or substrate will provide short protection while the layer of silica will be used to immobilize the acid. This present invention may be very useful in AGM batteries that have very thin plate spacing (e.g. <1.0 mm) such as e-bike, e-car, thin foil or even bi-polar batteries. The battery separator described herein could replace any one of the AGMs in an AGM VRLA battery.

### Example 3

There is another embodiment of this invention that is worth considering. Currently, the immediate application is to coat silica on an existing separator and thus far, the examples have described a PE separator. However, silica could be coated onto other types of separators such as those comprised of rubber, cross-linked phenolic resin and synthetic wood pulp. If the layer of silica provide a sufficiently small pore structure that prevent formation of pores (<5 microns), then a submicron substrate is no longer required. Therefore, another embodiment is to coat a thin non-woven web with a layer of silica. In this manner, the non-woven layer serves as a carrier web that allows a silica layer to be transferred to the battery. This non-woven could be a polymeric or even made from cellulosic materials such as currently used to produce pasting papers.

### Example 4

In this Example, the PE substrate of Example 1 is coated with a mixture of silica and carbon on a negative face of the substrate or the face that will face the negative electrode or plate in the battery.

### Example 5

In this Example, the PE substrate of Example 1 has silica coated across an entire face of the substrate. In this manner, the separator can be used to wrap the electrodes or plates.

### Example 6

In this Example, the PE substrate of Example 1 is coated with silica over a majority of the surface, except leaving an outer strip uncoated. The outer strip is preferably unribbed or has only mini ribs. In this way, the separator can be enveloped and sealed unto itself.

### Example 7

In this embodiment, the PE substrate is microporous, but has no ribs or protrusions. A silica material layer is applied on at least one surface thereof. It may be a partial surface or an entire surface coating. In an embodiment 7a, silica is applied on both faces or surfaces of the PE substrate. It may be applied on an entire or partial surface.

### Example 8

This Example is like Example 1, except the silica layer has a waterloss additive mixed in with the silica.

### Example 9

This Example is like Example 1 except that the PE substrate is replaced with a non-woven or woven material.

### Example 10

This Example is like Example 1 except that carbon may be applied to a negative face or surface of the substrate.

1. A battery separator comprising:
a polymeric substrate or flexible spine that is porous, microporous, or nonporous; and
a material layer, wherein the material layer comprises, consists of, or consists essentially of a material that has an oil absorption greater than 15 g of oil/100 g of material to 300 g of oil/100 g of material and wherein the material layer is provided on at least one surface of the polymeric substrate.

2. The battery separator of claim 1, the material has an oil absorption from 25 g of oil/100 g of material to 100 g of oil/100 g of material.

3. (canceled)

4. The battery separator of claim 1, wherein
the polymeric substrate is a polymeric porous membrane having a positive face and a negative face, and each of the positive face and the negative face optionally have ribs (selected from continuous ribs, discontinuous ribs, longitudinally extending ribs, latitudinally extending ribs, diagonally extending ribs, integral ribs, non-integral ribs, and mini ribs), protrusions, or both ribs and protrusions; and
the material layer is formed on at least one of the positive face, the negative face, or both the positive face and the negative face.

5. (canceled)

6. (canceled)

7. (canceled)

8. (canceled)

9. (canceled)

10. (canceled)

11. (canceled)

12. The battery separator of claim 4, wherein at least one outer edge of the polymeric porous membrane does not have ribs or protrusions or has only mini ribs or mini protrusions, wherein mini ribs or protrusions have a height of at most 100 microns to 250 microns from a face of the polymeric porous membrane.

13. The battery separator of claim 4, wherein the material layer is provided between at least two ribs on the polymeric porous membrane, at least 2 protrusions on the polymeric porous membrane, or between a rib and a protrusion on the polymeric porous membrane, but is not provided between any two mini ribs or mini protrusions on the polymeric porous membrane.

14. The battery separator of claim 13, wherein the material layer completely fills, partially fills, or overfills an area between at least two ribs on the polymeric porous membrane, at least 2 protrusions on the polymeric porous membrane, or between a rib and a protrusion on the polymeric porous membrane.

15. (canceled)

16. (canceled)

17. (canceled)

18. (canceled)

19. (canceled)

20. The battery separator of claim 1 wherein the polymeric porous membrane comprises a polyolefin and a filler.

21. (canceled)

22. (canceled)

23. The battery separator of claim 4, wherein the polymeric porous membrane has ribs, protrusions, or both ribs and protrusions on at least one face thereof, and the material layer is provide on at least one of the following:
a face of the polymeric porous membrane that has ribs, protrusions, or both ribs and protrusions; or
a face of the polymeric porous membrane that does not have ribs, protrusions, or both ribs and protrusions.

24. (canceled)

25. (canceled)

26. The battery separator of claim 23, wherein the material layer is provided on both of the following:
a face of the polymeric porous membrane that has ribs, protrusions, or both ribs and protrusions; and
a face of the polymeric porous membrane that does not have ribs, protrusions, or both ribs and protrusions.

27. The battery separator of claim 1, wherein the material layer or the material of the material layer has a bulk density of from 0.1 to 3.5 g/cm³.

28. The battery separator of claim 1, wherein the material layer further comprises, consists of, or consists essentially of a binder, and:
the binder is present in an amount less than 50%;
the binder is present in an amount from 1 to 20%;
the binder is soluble, partially soluble, or insoluble in battery acid such as H₂SO₄.

29. (canceled)

30. (canceled)

31. (canceled)

32. (canceled)

33. (canceled)

34. (canceled)

35. The battery separator of claim 1, wherein the material layer further comprises, consists of, or consists essentially of at least one other material, wherein:
the material is at least one selected from the group consisting of silica, precipitated silica, fumed silica, a talc, diatomaceous earth, a polysulfone, a polyester, PVC, and combinations thereof;
the material is an organic or inorganic particulate that is at least one of hydrophilic, acid loving, and acid stable;
the material comprises particles of different sizes; or
the material is selected from the group consisting of carbon, a water-loss-reducing agent, a fatty alcohol, a surfactant, a wetting agent, a zinc salt, any other battery performance-enhancing additive, and combinations thereof.

36. (canceled)

37. (canceled)

38. (canceled)

39. (canceled)

40. The battery separator of claim 1, wherein another material layer is provided on top of the material layer.

41. The battery separator of claim 4, wherein at least one of the positive and the negative face does not have any ribs or protrusions.

42. (canceled)

43. The battery separator of claim 1, wherein an oil content of the polymeric substrate is from 1 to 20%, from 1% to 10%, or from 1% to 5%.

44. (canceled)

45. (canceled)

46. The battery separator of claim 1, wherein the polymeric substrate is a woven or nonwoven polymeric substrate, a sheet, or an envelope.

47. (canceled)

48. A lead acid battery, including a flooded lead acid battery or a valve-regulated lead acid battery, comprising:
a negative plate;
a positive plate;
an acid-containing electrolyte; and
a battery separator between the positive and the negative plate, wherein the battery separator is a battery separator as described in claim 1.

49. The lead acid battery of claim 48, wherein the lead acid battery is a cylindrical-cell-type lead acid battery or a prismatic-cell-type lead acid battery.

50. (canceled)

51. The lead acid battery of claim 48, wherein the material layer is formed: between the polymeric substrate and the positive plate;
Between the polymeric substrate and the negative plate; or
between both the polymeric substrate and the positive plate and between the polymeric substrate and the negative plate.

52. (canceled)

53. (canceled)

54. The lead acid battery of claim 48, wherein the lead acid battery is a valve-regulated lead acid battery or a flooded lead acid battery.

55. (canceled)

56. The lead acid battery of claim 48 wherein at least one additional layer is formed between the polymeric substrate and the positive plate, between the polymeric substrate and the negative plate, or between both the polymer substrate and the positive plate and between the polymeric substrate and the negative plate, and wherein the additional layer comprises at least one of carbon, a water-loss-reducing agent, a fatty alcohol, a surfactant, a wetting agent, a zinc salt, any other battery-performance-enhancing additive, and combinations thereof.

57. (canceled)

58. The lead acid battery of claim 48, wherein the battery separator does or exhibits at least one, at least two, at least three, or all four of the following:
immobilizes at least a portion of the acid-containing electrolyte;
improves oxidation resistance;
is not infinitely compressible; and
restrains active material in at least one of the positive or negative plates (NAM or PAM).

59. (canceled)

60. (canceled)

61. A Valve-Regulated Lead Acid (VRLA) battery, wherein the improvement comprises replacing at least one absorptive glass mat (AGM) with a battery separator as described in claim 1.

62. The VRLA battery of claim 61, wherein the battery is a cylindrical-cell-type battery or a prismatic-cell-type battery.

63. (canceled)

64. The VRLA battery of claim 61, wherein at least one additional layer is formed between the polymeric substrate and a positive plate, between the polymeric substrate and a negative plate, or between both the polymer substrate and a positive plate and between the polymeric substrate and a negative plate, and wherein the additional layer comprise at least one of carbon, a water-loss-reducing agent, a fatty alcohol, a surfactant, a wetting agent, a zinc salt, any other battery-performance-enhancing additive, and combinations thereof.

65. (canceled)

66. The VRLA battery of claim 61, wherein the battery separator exhibits or does at least one, at least two, at least three, or all four of the following:
immobilizes at least a portion of the acid-containing electrolyte;
improves oxidation resistance;
is not infinitely compressible; and
restrains active material in at least one of the positive or negative plates (NAM or PAM).

67. (canceled)

68. (canceled)

69. The battery separator of claim 1, wherein the polymeric substrate has a thickness of 50 to 500 microns or from 50 to less than 150 microns.

70. The battery separator of claim 69, wherein the combined thickness of the polymeric substrate and the material layer is from 100 microns to 4 mm.

71. (canceled)

72. The battery separator of claim 1, wherein the polymeric substrate has a porosity greater than 50%, greater than 55%, greater than 60%, greater than 65%, greater than 70%, greater than 75%, greater than 80%, greater than 85%, or greater than 90%.

73. (canceled)
